(19) United States
(12) Patent Application Publication
(10) Pub. No.: US 2026/0127187 A1
(43) Pub. Date: May 7, 2026

(54) TIME EFFICIENT DECODING OF SERIES-VARIANT DATA SEQUENCE

(71) Applicant: INTERNATIONAL BUSINESS MACHINES CORPORATION, Armonk, NY (US)

(72) Inventors: William Andrew SIMON, Adliswil (CH); Irem BOYBAT KARA, Adliswil (CH); Elena FERRO, Adliswil (CH); Riselda KODRA, Rueschlikon (CH)

(21) Appl. No.: 18/938,624

(22) Filed: Nov. 6, 2024

(51) Int. Cl. G06F 9/30

(52) U.S. Cl. CPC G06F 16/2458

(57) ABSTRACT

A time efficient, data sequence decode process is provided. The process includes decoding, by a decoder, a series-variant data sequence, where the decoding includes storing, by the decoder in intermediate storage, received timestep values of the series-variant data sequence, and lookahead data processing, by the decoder, a specified number of future timestep values of the series-variant data sequence from a particular timestep. The lookahead data processing for the particular timestep proceeds based on the specified number of future timestep values from the particular timestep being stored by the decoder in the intermediate storage.

### BACKGROUND

One or more aspects relate, in general, to facilitating data processing, and more particularly, to improving decode processing of series-variant data, such as series-variant datastream sequences.

Series-variant signals or datastreams, occur in a variety of data processing applications today, such as in the domain of natural language processing (e.g., processing of audio data, handwriting data, etc.), as well as medical processing (e.g., genome sequencing, electrocardiogram processing, etc.). As part of the data processing, the series-variant signal is often converted, or decoded, into discrete units.

Processing of a series-variant datastream can take various forms, such as a Conditional Random Fields (CRF) process, which in embodiments can be paired with Connectionists Temporal Classification (CTC) to predict, for instance, when a data sequence transitions between characters or remains on a current character. CRFs are often applied to position of speech tagging and named-entity recognition, while CTC is useful in domains involving transforming a time variant or analog signal to a series of classifications, such as audio or handwriting classification, or genome sequencing. CRF-CTC decoders have recently been applied to genome sequencing to good effect. In practice, Conditional Random Fields (CRF) decoding with higher state lengths improve the decoder's ability to differentiate between states, particularly when a single timestep can be composed in multiple tokens (e.g., characters), and Connectionist Temporal Classification (CTC) processing facilitates the decoder's ability to differentiate between successive timesteps that refer to the same token.

### SUMMARY

Certain shortcomings of the prior art are overcome, and additional advantages are provided herein through the provision of a method of enhancing data processing. The method includes decoding, by a decoder, a series-variant data sequence. The decoding includes storing, by the decoder in intermediate storage, received timestep values of the series-variant data sequence. Further, the decoding includes lookahead data processing, by the decoder, a specified number of future timestep values of the series-variant data sequence from a particular timestep, where the lookahead data processing for the particular timestep proceeds based on the subset of future timestep values from the particular timestep being stored by the decoder in the intermediate storage.

Computer program products and systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the disclosed inventive aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present disclosure;

FIG. 2 depicts one embodiment of a program product with decode code, in accordance with one or more aspects of the present disclosure;

FIG. 3 depicts one embodiment of a decode process, in accordance with one or more aspects of the present disclosure;

FIG. 4 depicts one example of a portion of a series-variant data sequence to be decoded into discrete text, in accordance with one or more aspects of the present disclosure;

FIG. 5 depicts one embodiment of a Conditional Random Fields (CRF) process, a variation of which can be implemented by decode code or a decode process, in accordance with one or more aspects of the present disclosure;

FIG. 6 depicts a schematic of one embodiment of a decoder, in accordance with one or more aspects of the present disclosure;

FIG. 7 depicts a simplified state transition step as a potential input timestep value to a decoder, such as the decoder of FIG. 6, in accordance with one or more aspects of the present disclosure;

FIG. 8A is a block diagram of a lookbehind data process of a decoder, such as the decoder of FIG. 6, in accordance with one or more aspects of present disclosure;

FIG. 8B depicts further details of one embodiment of the lookbehind data process of FIG. 8A, in accordance with one or more aspects of the present disclosure;

FIG. 9A depicts a block diagram of one embodiment of intermediate storage of a decoder, such as the decoder of FIG. 6, in accordance with one or more aspects of the present disclosure;

FIG. 9B depicts further details of one embodiment of intermediate storage of a decoder with (in part) received input timestep values for forwarding to (or retrieval by) a lookahead data process of the decoder, in accordance with one or more aspects of the present disclosure;

FIG. 10A depicts a block diagram of multiple instances of a lookahead data process of a decoder, such as the decoder of FIG. 6, in accordance with one or more aspects of the present disclosure;

FIG. 10B depicts further details of one embodiment of a lookahead data process of a decoder, such as decoder of FIG. 6, in accordance with one or more aspects of the present disclosure;

FIG. 11A depicts one embodiment of a combine process for combining a lookbehind data processing result and a lookahead data processing result to obtain a combined decode output value for a particular timestep, in accordance with one or more aspects of the present disclosure;

FIG. 11B depicts one embodiment of post-processing a combined output value of FIG. 11A, such as by normalization of the value, or such as by addition, in accordance with one or more aspects of the present disclosure;

FIG. 11C depicts a further embodiment of post processing a combined output value of FIG. 11A, such as by finding a column containing a maximum value, in accordance with one or more aspects of the present disclosure;

FIG. 12 depicts one embodiment of a digital signal processor with a decoder, such as the decoder of FIG. 6, for decoding a series-variant data sequence, in accordance with one or more aspects of the present disclosure;

FIG. 13 is a flow diagram of a design process used in semiconductor design, manufacture, and test, in which aspects of the present disclosure can be employed;

FIG. 14 depicts a further example of integrated circuit fabrication, in accordance with one or more aspects of the present disclosure;

FIG. 15 shows an exemplary high-level electronic design automation (EDA) tool flow, in which aspects of the present disclosure can be employed; and

FIG. 16 depicts one example of the impact of varying considered future steps on genome sequence accuracy with two different operators, in accordance with one or more aspects of the present disclosure.

### DETAILED DESCRIPTION

Aspects of the present disclosure and certain features, advantages, and details thereof, are explained more fully below with reference to the non-limiting example(s) illustrated in the accompanying drawings. Descriptions of well-known software, systems, devices, tools, processing techniques, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, etc. One or more aspects of an illustrative embodiment can be implemented in software, hardware, or a combination thereof.

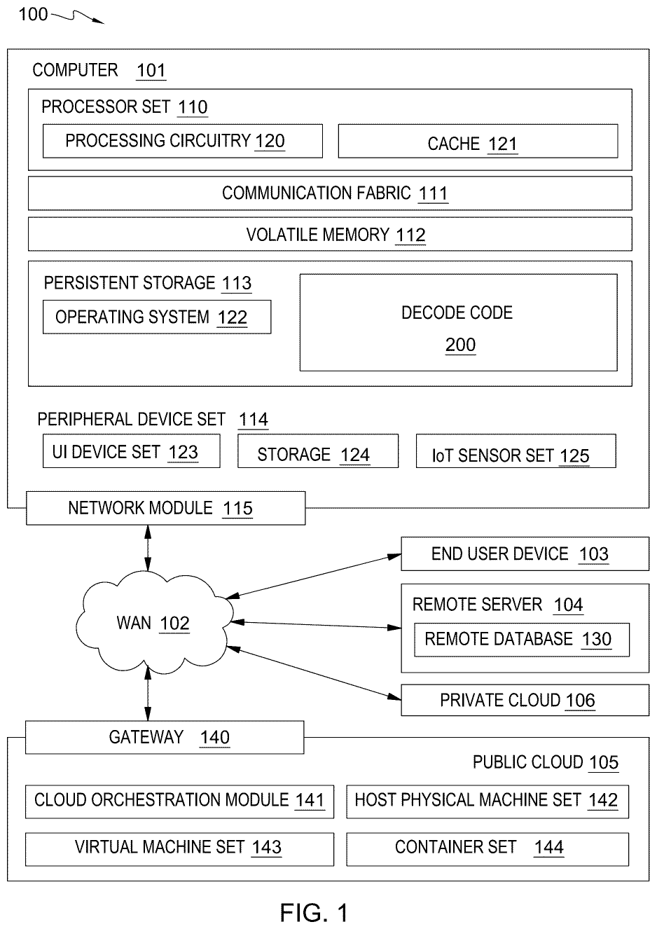

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1, including operating system 122 and decode code 200, which are stored in persistent storage 113.

In one or more aspects, a data processor, method, computer program product and system are provided herein to facilitate data processing, and in particular, to improve decode (or convert) processing of a series-variant data sequence, such as a time-series-variant datastream sequence, a spatial-series-variant datastream sequence, a frequency-series-variant datastream sequence, etc. In one or more embodiments, decode code and a decode process are provided for predicting a value for a given timestep interval based on all prior input values of a particular data sequence of values (e.g., lookbehind data processing) and only a subset, or specified number, of future values of the data sequence (lookahead data processing), where the specified number is less than the total number of future timesteps in the datastream sequence. Note that as used herein, “timestep” refers to any step in a series-variant data sequence, such as a time-series-variant datastream sequence, a spatial-series-variant datastream sequence, a frequency-series-variant datastream sequence, etc. In one or more specific embodiments, Conditional Random Fields (CRF) decoding of state transitions of a series is provided, such as a time series for a genome sequence. The lookahead processing parameterizes to looking ahead to any set, or specified, number of values, with a trade off between memory and/or area overhead and prediction accuracy verses computation latency. In one or more embodiments, the decode code and decode process include multiple chained stages, where different methods of combining the lookbehind data processing and lookahead data processing result values can be applied across the different stages. For instance, in one or more embodiments, lookbehind data processing results can be combined via logsumexp on pass one, and then max on pass two, by way of example only. As another example, a different future subset size could be considered for each pass. In embodiments, one or more post-processing steps can optionally be applied to finalize a decode output, depending on the implementation.

One or more aspects of the present disclosure are incorporated in, performed and/or used by a computing environment. As examples, the computing environment can be of various architectures and of various types, including, but not limited to: digital signal processing, edge-based computing, personal computing, client-server, distributed, virtual, emulated, partitioned, non-partitioned, cloud-based, quantum, grid, time-sharing, clustered, peer-to-peer, mobile, having one node or multiple nodes, having one or more processor sets, each with one processor or multiple processors, and/or any other type of environment and/or configuration, etc., that is capable of executing a process (or multiple processes) that, e.g., perform processing, such as disclosed herein. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As illustrated in FIG. 1, computing environment 100 contains an example of an environment for the execution of at least some of the computer code involved in performing the inventive methods, such as decode code or block 200. In addition to code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computing-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computing-implemented method, such that the instructions thus executed will instantiate the methods specified in flowcharts and/or narrative descriptions of computing-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in code 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

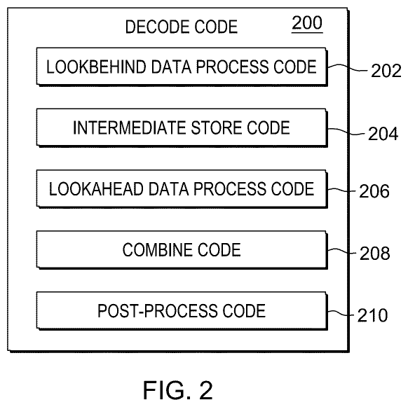

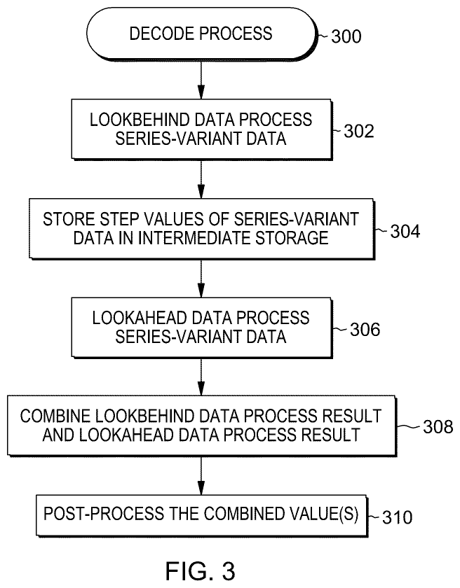

By way of example, one or more embodiments of a decode code and workflow are described initially with reference to FIGS. 2-3. FIG. 2 depicts one embodiment of decode code or module 200 that includes code or instructions to perform decode processing, in accordance with one or more aspects of the present disclosure, and FIG. 3 depicts one embodiment of a decode process workflow, in accordance with one or more aspects of the present disclosure.

Referring to FIGS. 1-2, decode code 200 includes, in one example, various code or sub-modules used to perform processing, in accordance with one or more aspects of the present disclosure. The sub-modules are, e.g., computer-readable program code (e.g., instructions) in computer-readable media (e.g., persistent storage (e.g., persistent storage 113, such as a disk) and/or a cache (e.g., cache 121), as examples). The computer-readable media can be part of a computer program product and can be executed by and/or using one or more processors and/or computers, such as computer(s) 101; one or more processor sets 110; processors, such as one or more processors of processor set 110; and/or processing circuitry, such as processing circuity of processor set 110, etc.

As noted, FIG. 2 depicts one embodiment of decode code 200 which, in one or more implementations, includes, or facilitates, decode processing (or convert processing) in accordance with one or more aspects of the present disclosure. In the embodiment of FIG. 2, example code of decode code 200 includes lookbehind data process code 202 to lookbehind data process timestep values of a data sequence, such as a datastream sequence, to produce a lookbehind data processing result for a particular timestep. As noted, “timestep” is used herein to refer to any step in a series-variant data sequence. In one or more embodiments, the process includes combining timestep values from all prior timesteps of the data sequence into the result for a particular timestep. In embodiments, decode code 200 further includes intermediate store code 204 to store, for instance, a running vector and/or matrix representing lookbehind data processing results for the data sequence. In implementation, lookbehind data processing code 202 and intermediate store code 204 amalgamate the input timestep values in a streaming fashion. In addition, in one or more embodiments, the decode code stores in the intermediate storage the received timestep values of the series-variant data sequence being decoded. The timestep values are stored, in one embodiment, sequentially as they are received.

In embodiments, decode code 200 further includes lookahead data process code 206 to lookahead data process a specified (or set) number of future timestep values from a particular timestep. The lookahead data processing proceeds based on the specified number of future timestep values being received and stored by the decoder in the intermediate storage. In order to process multiple steps in parallel, the lookahead data process code or logic can be copied any desired number of times, where it is assumed that each processes one step. In embodiments, decode code 200 further includes combine code 208 to combine, for instance, the lookbehind data processing result and the lookahead data processing result for a particular timestep to produce an output which is dependent on the results of all the past and specified future timestep values. In embodiments, decode code 200 optionally includes post-process code 210 for post processing the combined value via, for instance, normalization (in one embodiment) or finding a column containing a maximum value (in another embodiment). The output of the post-process code can be passed to either a next lookbehind and/or lookahead data process stage, or output as an output of the decode process.

Note also that although various code or sub-modules are described herein, a decode code, such as disclosed, can use, or include, additional, fewer, and/or different code/sub-modules. A particular code can include additional code, including code of other sub-modules, or less code. Further, additional and/or fewer code/sub-modules can be used. Many variations are possible.

In one or more embodiments, the decode code is used, in accordance with one or more aspects of the present disclosure, to perform decode processing. FIG. 3 depicts one example of a decode process 300, such as disclosed herein. The process is executed, in one or more embodiments, by a computer (e.g., computer 101 (FIG. 1), a computing device (such as a digital signal processor, an edge-based computing device, etc.) and/or one or more processor sets, such as a processor or processing circuitry (e.g., of processor set 110 of FIG. 1). In one example, code or instructions implementing the process, are part of a code or module, such as decode code 200 of FIGS. 1-2. In other examples, the code can be included in one or more other modules and/or one or more other sub-modules of one or more other modules. Various options are available.

As illustrated in FIG. 3, in one example, decode process 300 executing on one or more computers (e.g., computer 101 of FIG. 1), one or more computing devices, one or more processor sets (e.g., processor set 110 of FIG. 1, such as a processor or processing circuitry of the processor set) performs decode processing such as described herein, which includes, in one or more embodiments, lookbehind data processing the series-variant data sequence 302 to process lookbehind data values from each timestep interval of the data to produce a lookbehind data processing result for each timestep. In one or more embodiments, the process includes combining timestep values from all prior timesteps of the data sequence being processed. In embodiments, decode process 300 further includes storing the step values of the series-variant data sequence in intermediate storage 304, as they are received by the decoder logic. In addition, in one or more embodiments, the decoder stores, in intermediate storage of the decoder, a running vector and/or matrix representing the lookbehind data processing results for the respective datastream sequence timestep intervals. In implementation, the lookbehind data processing 302 and store process 304 amalgamate the received timestep values in a streaming fashion.

In embodiments, decode process 300 further includes lookahead data processing 306 to lookahead data process, for a particular timestep interval of the data sequence, a specified number of future timestep values from that timestep. Note in this regard that, in embodiments, the specified number of future timestep values is prespecified for the decoder, and can be tailored based on the particular decode application being implemented by the decoder. In one or more embodiments, the specified number of future timestep values is less than the total number of remaining future timestep values in the series-variant data sequence. Lookahead data processing proceeds based on (e.g., in response to) the specified number, or subset, of future timestep values having been stored by the decoder in the intermediate storage of the decoder. For instance, in one or more embodiments, responsive to the specified number of future timestep values being stored into the intermediate storage, the lookahead data processing automatically proceeds using the stored future values. In order to process multiple steps in parallel the lookahead data process code can be duplicated any desired number of times, this is, where each process is one step. In embodiments, decode process 300 further includes combine process 308 to combine, for instance, the lookbehind data processing result (or value) and the lookahead data processing result (or value) to produce an output dependent on the results of all the past and the partial future timestep values. In embodiments, decode process 300 optionally includes post-processing 310 for post processing the combined value(s) via, for instance, normalization (in one embodiment), or finding a column containing a maximum value (in another embodiment), etc. The output of the post-processing can be passed to either a next lookbehind and/or lookahead stage, or output as an output of the decode process.

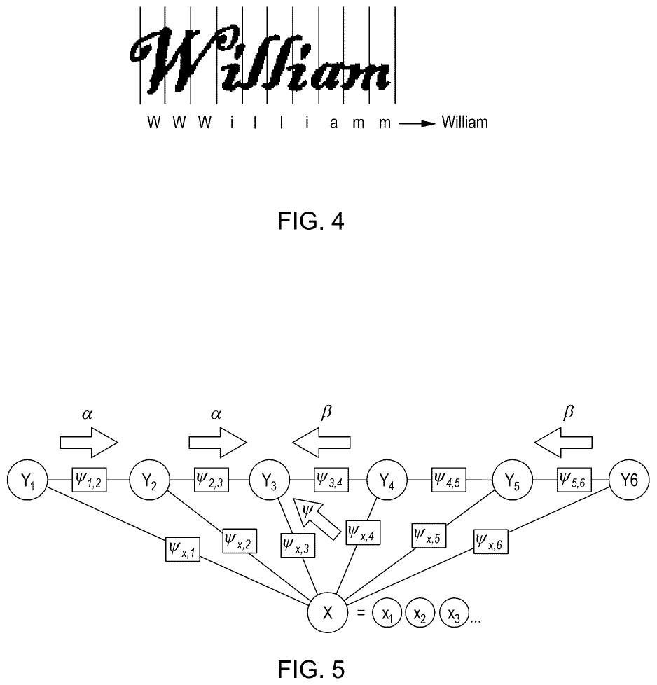

As noted, series-variant signals or datastreams occur in a variety of data processing applications today, such as in the domain of natural language processing (e.g., processing of audio data, handwriting data, etc.) as well as medical data processing (e.g., genome sequencing, electrocardiogram processing, etc.). As part of the processing, the series-variant signal is often converted or decoded into discrete units for different timestep intervals of the datastream sequence. FIG. 4 depicts one example of a handwriting data sequence segmented into multiple timestep intervals with the values or data within the respective intervals to be decoded by decode logic or decode processes, such as described herein. Note that, in one or more embodiments, the decoder or decode process can be part of a processor, such as a digital signal processor, accelerator, edge-based processor, or other computing device, computer, etc., and can be implemented in hardware coupled with other processing, such as preprocessing to process a received datastream for decoding by the decoder. For instance, in one or more embodiments, the preprocessing can include a neural network that generates probabilities based on the received datastream, with the decoder decoding the probabilities to generate discrete outputs for the different timesteps, such as described herein.

In embodiments, the decoder-implemented processing of a series-variant data sequence can take a variety of forms, including a Conditional Random Fields (CRF) process. Note that a Conditional Random Fields process is discussed herein by way of example only, and without limitation. As illustrated in FIG. 5, conventionally a CRF process conserves all steps prior to and after a particular timestep in a series-variant data sequence when calculating a most likely discrete value at a particular timestep. A linear chain CRF example is depicted in FIG. 5. The linear chain CRF is a specific type CRF that represents a chain of hidden variables that depend linearly on one another, as well as the known input variables. In this case, the value of Y is unknown, and is traditionally calculated using information from all values of X, which are known. In one or more embodiments, this can be accomplished by amalgamating information recursively between Yₙ and Yₙ₊₁ in successive values of α and Yₙ and Yₙ₋₁ in successive values of β. While this approach has the benefit of informing the choice of the discrete value for Yₙ, using information from the entire time series of X results in the entire time series of X needing to be generated (or retrieved) and stored before Y can begin to be generated, resulting in pipeline bottlenecks or bubbles if its desired output data in a streaming manner where, for instance, X can be produced by a sensor array or other similar continuous signal device.

Disclosed herein are a decoder, decode code, and decode processes for producing outputs of Y before all values of X have been determined by considering only a subset of future states of X when determining the equations for β. The specified number of values in the subset is defined by the required accuracy and/or hardware requirements. Hardware requirements can be performance, memory, device area, or other constraints. Further, the decoder can be implemented, in one or more embodiments, as a special purpose pipeline hardware accelerator, such as described herein. The decoder can be configured for a variety of tasks and implementations, including, for instance, as POS inference, NLP tasks, genomics tasks, such as basecalling, etc. A hardware component implementing the aspects disclosed herein will enable low power, low latency, high throughput streaming of token (or timestep) decoding in a smaller area footprint suitable for embedded devices, such as in-field genome sequencing devices.

In one or more embodiments, a hardware decoder, decode code, and decode processes are disclosed herein for providing a streaming output using an application, such as a CRF decode process, or similar decode process, while considering only a specified number of future timesteps for the lookahead data process, along with all past timestep values seen thus far (i.e., for a particular timestep), for the lookbehind data process. Note in this regard that the specified number of future timestep values can be preset for a particular decode application. In other embodiments, different specified numbers of future timesteps can be used in different stages of a decode process, such as for different lookahead data process stages of the decoder. For instance, the combination of lookbehind data processing and lookahead data processing can also be changed in multiple stages to transform the series-variant data sequence, or datastream segment, for improved accuracy, with the ability to change the lookahead value (that is the specified number of future timestep values to be considered for a particular timestep) in different stages, as desired for a particular application. For instance, the operation for generating the amalgamation values/vectors/matrices α and β can be varied between stages. In one or more embodiments, a post-processing stage can also be included at the output of the final lookahead/lookbehind stage to finalize the discrete output value from the decoder. Note that the choice of lookahead value at each stage has a direct impact on the amount of device area and memory area required by the decoder hardware, as well as effects latency verses accuracy of the discrete output values.

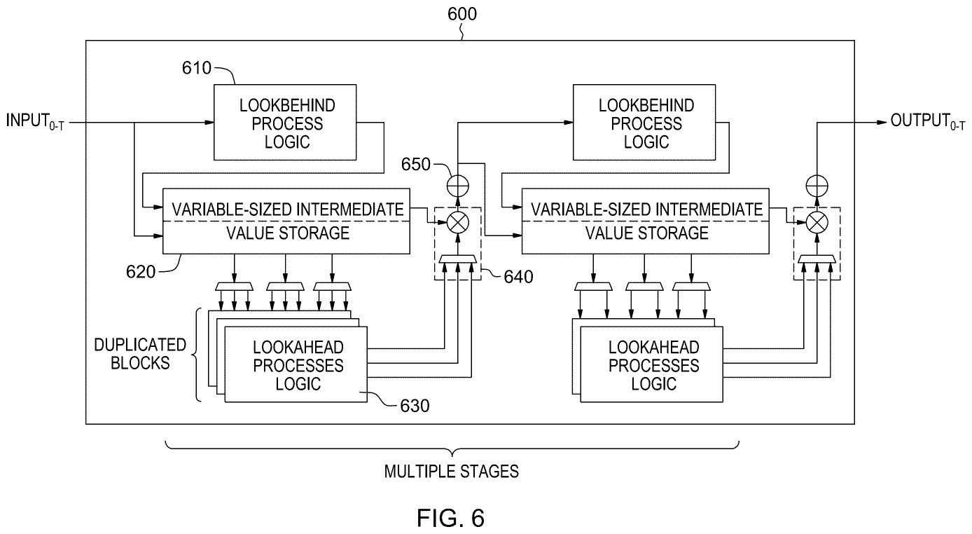

FIG. 6 depicts a schematic of one embodiment of a decoder 600, or decode logic, in accordance with one or more aspects of the present disclosure. As illustrated, in one or more embodiments, decoder 600 includes multiple stages of lookbehind process logic 610, intermediate storage 620 and one or more lookahead process logic 630 components, as well as combine logic 640 and post-process logic 650.

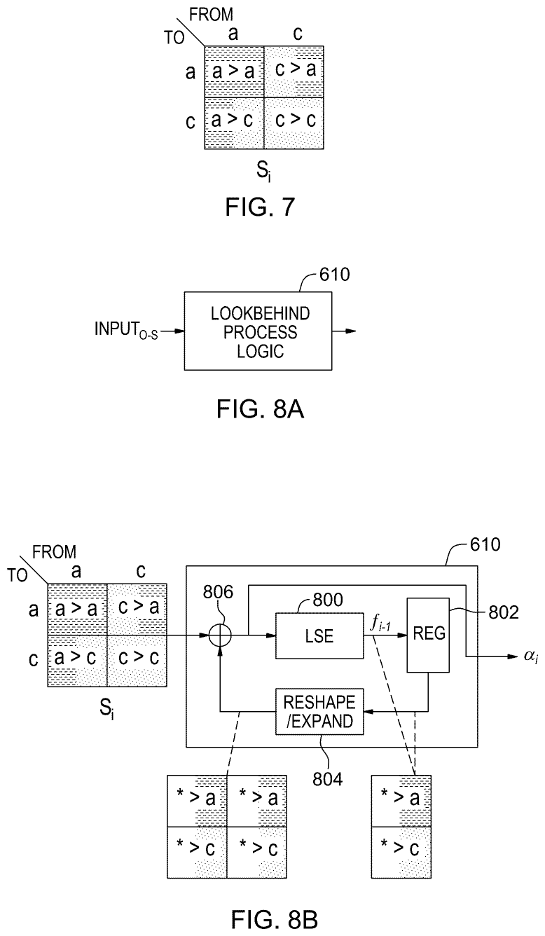

Those skilled in the art will note that the particular circuit implementation illustrated in FIG. 6 is one example only of a decoder, in accordance with one or more aspects disclosed herein. For instance, decoder 600, with multiple lookbehind and lookahead stages, is one circuit embodiment only of incorporating or utilizing one or more aspects disclosed herein. In the embodiment of FIG. 6, each stage includes hardware and processes implementing the lookbehind data process operations, lookahead data process operations, and variable-sized intermediate storage disclosed. As discussed, the size of the intermediate storage will depend, in part, on the particular specified number of future timestep values to used by the lookahead data process operations, where the specified number of future timestep values at a particular timestep is less than the total number of future timestep values in the series-variant data sequence to be processed. For instance, in one or more embodiments, the total number of future timestep values in a sequence can depend on the application, and can be, for instance, tens or more, a one hundred or more, a thousand or more, etc., and the specified number of future timestep values might be a fraction of that number, for instance, ten future timestep values out of a hundred or more. In embodiments, the specified number of future timestep values can be predetermined for a particular decode application implemented by the decoder. In this manner, the intermediate storage required at each stage can advantageously be sized or tailored to the particular amount of storage required for the specified number of future timestep values (in one embodiment). The number of instances (or copies) of the lookahead data process logic can also be parameterizable and dependent on the number of future steps to be considered when determining the output of a current timestep interval. For instance, processing can be improved by having the same number of instances as the specified number of future timestep values used by the lookahead data processing. Combine process logic 640 and post-process logic 650 are, in one or more embodiments, parameterizable operations for combining and post-processing, respectively, each stage's output for a particular decode process application. The final post-processing step provides the OUTPUT_{0-T} from the INPUT_{0-T} series-variant data sequence. Further details of lookbehind process logic 610, intermediate storage 620, lookahead process logic 630, combine logic 640 and post-process logic 650 are described below with reference to FIGS. 7-11C.

By way of example, FIG. 7 depicts a simplified state transition timestep value as a potential input to a decoder or decode process such as disclosed herein, for instance, to decoder 600 of FIG. 6. The input can be, or include, a list/vector/array/matrix of inputs received at the decoder from some producer circuit or process. For instance, the input can be an amplitude value datastream from a sensor, a vector of probability of belonging to one or more set of states from a neural network, etc., depending on the particular circuit application. As a genome sequence example, the output of a neural network (e.g., pre-process logic coupled to the decoder) predicts the probability of a state transition between the four possible ATCG base-pairs in a DNA sequence. FIG. 7 illustrates one possible input timestamp value to the decoder, where a transition matrix is shown between two possible discrete output values. The dimensions of the input are not limited to that illustrated in FIG. 7. In one or more embodiments, each value represents a log-probability of transitioning from one state in the sequence to another.

FIG. 8A is a block diagram representation of a lookbehind data process logic 610 that amalgamates the input timestep values in a streaming fashion, where the input is labeled INPUT_{0-S}, and is representative of a series-variant datastream sequence to be decoded. FIG. 8B is a more detailed schematic of one embodiment of lookbehind data process logic 610 of FIG. 8A. As illustrated, in one embodiment, lookbehind data process logic 610 includes a LogSumExponent (LSE) 800 circuit component to amalgamate previous timestep values. In implementation, lookbehind data process 610 generates αᵢ at step i using sᵢ and αᵢ₋₁. The input is assumed to be log-likelihoods of transitions between two states ‘a’ and ‘c’, such as in the example of FIG. 7. A forward vector ‘f’ is generated via the LogSumExponent (LSE) function 800 along the rows, which sums the probability of transitioning to each state from either of the other states. The vector fᵢ₋₁ is added 806 to sᵢ to generate αᵢ, representing (at a particular timestep) the likely transition from one state to another state based on sᵢ and all previous states. In operation, fᵢ₋₁ is output to a register 802, which is obtained by reshape/expand logic 804 and used to reshape and/or expand the output fᵢ₋₁ for combining 806 with sᵢ, with the result being to obtain the αᵢ value at the input of LSE circuit 800, which is output to the intermediate storage. As shown in FIG. 6, sᵢ is also output to the intermediate storage, while the lookahead data process runs, until the output of the lookahead data process output is ready to be combined with OUTPUTᵢ.

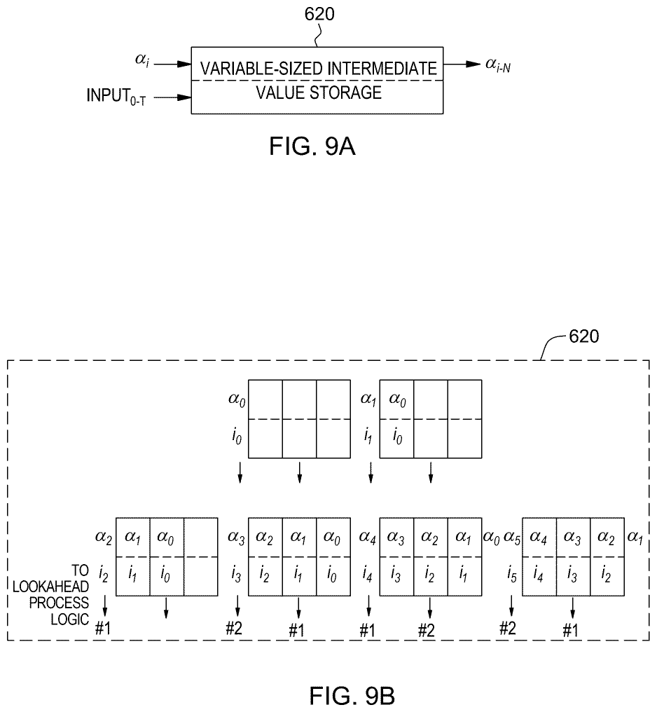

FIG. 9A is a block diagram of one embodiment of intermediate storage 620 (or memory) of a decoder, such as decoder 600 of FIG. 6, in accordance with one or more aspects of the present disclosure, and FIG. 9B depicts exemplary details of one embodiment of intermediate storage 620 with received input timestamp values for forwarding (or retrieval by) a lookahead process of the decoder, in accordance with one or more aspects disclosed herein. As illustrated in FIG. 9A, intermediate storage 620 of the decoder can be a variable-sized intermediate value storage that receives as input the output of the lookbehind data process logic αᵢ, as well as in sequence the INPUT_{0-T} timestamp values, and provides α_{i-N} as output to combine logic, such as combine logic 640 of the decoder of FIG. 6.

As described herein, intermediate storage 620 of the decoder is provided for, in part, serving the lookahead process logic, such as lookahead process logic 630 of the decoder 600 of FIG. 6. The variable-size intermediate value storage receives input steps sequentially, and the lookahead process cannot operate until the number of future values to be considered for a particular timestep interval has arrived at the decoder, for example, has been stored into intermediate storage 620. In the case of a CRF process application, the lookahead process requires as input s_{i+N} as input, where N is a specified number of future steps to be considered in the process, including N−1, N−2, . . . , N=i+1. Thus, the intermediate storage buffers and sends the input values to the lookahead process logic as needed, as illustrated in FIG. 9B. In this case, two future values are considered, by way of example only. In implementation, there is a trade-off between memory size of the intermediate storage and number of future timesteps to be passed to the lookahead process logic. If implementing a decoding algorithm that does not require future steps to be passed in descending order, then this requirement is removed. However, the α must still be buffered in the intermediate storage.

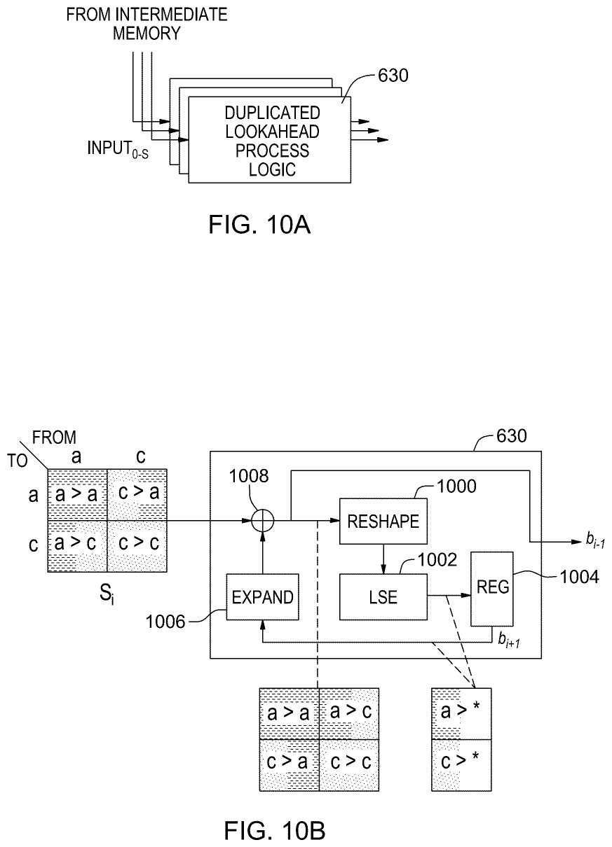

FIG. 10A is a block diagram of multiple instances of lookahead data process logic 630 of decoder 600 of FIG. 6, and FIG. 10B depicts further details of one embodiment of a lookahead process logic for a decoder, in accordance with one or more aspects of the present disclosure. As illustrated, the INPUT_{0-S} is received from the intermediate storage or memory of the decoder into the respective instances of the lookahead process logic 630. In this embodiment, lookahead process logic 630 considers a specified number of future steps when determining the output of a current step, as described. In order to process multiple steps in parallel, it can be advantageous to duplicate the lookahead process logic multiple times, that is, assuming that each process is one step. One detailed implementation of this is depicted in FIG. 10B. In one embodiment, timesteps representing state transitions buffered in the intermediate storage are passed to the lookahead process logic in reverse order. In the embodiment of FIG. 10B, the timestep values are reshaped 1000 such that rows include transitions starting from the same state. An LSE function 1002 is applied, producing a ‘b’ vector, which is buffered in register 1004, where each value is the total probability of transition from one state from the previous step. Note in this regard that ‘b’ can be expanded 1006 and added 1008 to step sᵢ₋₁ informing its likelihood of transitions from the future step. This process is recursively performed until the total number of future steps parameterized to be considered have been consumed by the lookahead process logic, thus producing a β value that is passed on to the next step for combining with the previously generated α value currently buffered in intermediate storage. Those skilled in the art will note that, similar to the intermediate storage discussion, configuring the lookahead process logic to consider more future timesteps requires more lookahead process logic instances to be included in the design as each lookahead process instance attends to one timestep at a time. Thus, looking ahead for, for instance, two steps, requires two lookahead process logic circuits to be provisioned, corresponding to the #1 and/or #2 outputs in FIG. 9B, by way of example.

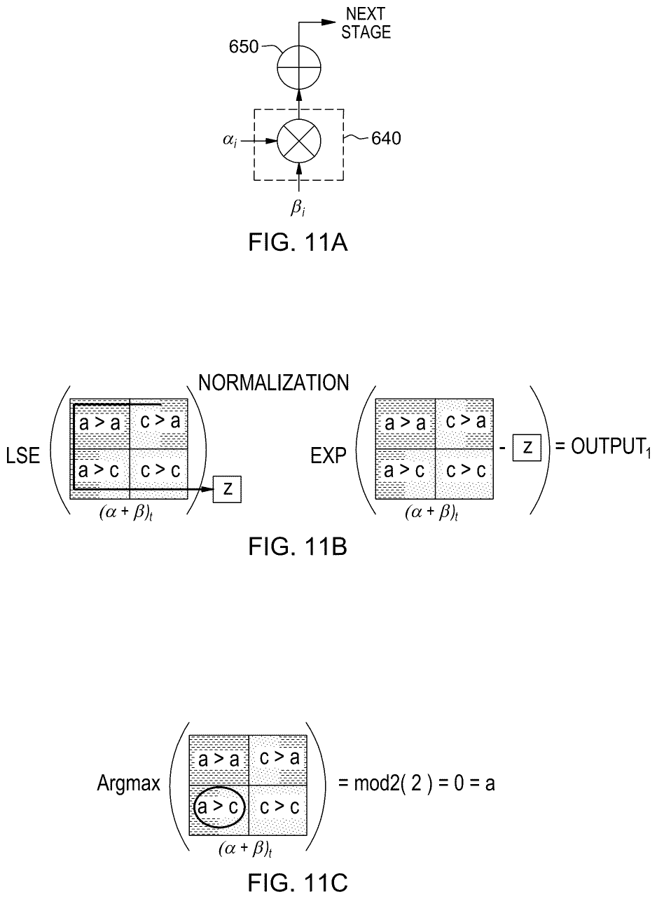

FIG. 11A depicts one embodiment of a combine process logic 640 for combining a lookbehind data processing result and a lookahead data processing result to obtain a combined decode output value, which can then be post-processed 650, as desired for a particular application. For instance, after computing ‘α’ and ‘β’ these values can be combined as desired for a particular application to produce an output that is based on the results of the past and future step processing, as described. As one example only, the two result values can be added together to produce the combined value. Those skilled in the art will note, however, that other combination approaches can be used as desired for a particular application. Once combined, the new combined value can be post-processed 650. For instance, normalization can be applied as depicted in FIG. 11B, or, for instance, a column containing the maximum value can be found, as illustrated in the example of FIG. 11C. For example, argmax of transitions can be applied to the combined value, followed by a mod to define the column and discrete value associated with the maximum value (e.g., a≥c). The output of the post-processing stage can be passed to either a next lookbehind and/or lookahead stage, or as output of the decoder, depending on the application.

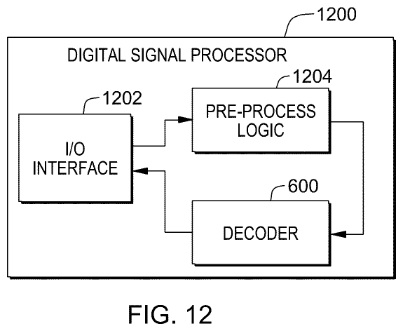

FIG. 12 depicts one embodiment of how a decoder, such as decoder 600 of FIG. 6, can be integrated into a larger hardware device, such as a digital signal processor 1200, accelerator, etc., that has, for instance, an input/output (I/O) interface 1202 and pre-process logic 1204, such as a neural network. In one or more embodiments, one or more of pre-process logic 1204 and decoder 600 can be implemented in a compute in memory (CIM) accelerator or processor, with CIM units and digital processing units (DPUs). The CIM and DPU units can be responsible for running the neural network, which can consume, for instance, time series or similar signals in a streaming fashion, producing values on the fly. By implementing the decode disclosed herein on the accelerator, the streaming process can be extended to the decoding step, to produce discrete outputs from the series-variant inputs provided by the pre-process logic.

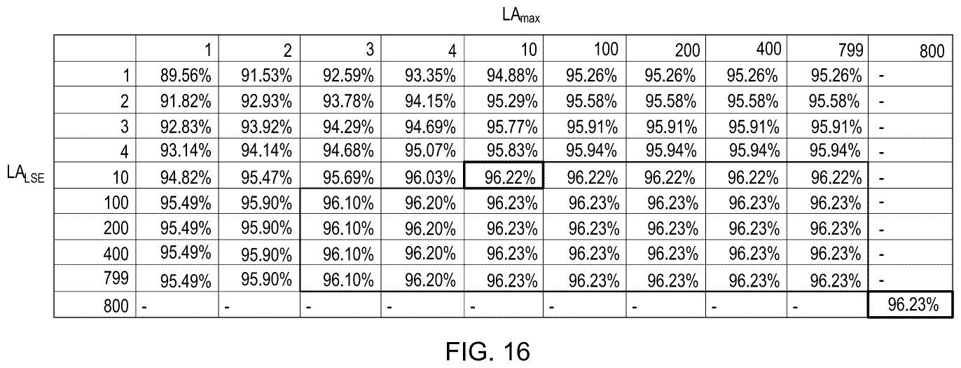

For instance, in one embodiment, the digital signal processor 1200 of FIG. 12 can consume amplitude values coming from a genome sequencing device. The network and accelerator predict the sequence of ATCG values based on the amplitude input. In one or more embodiments, two stages can be utilized, similar to that depicted in FIG. 6, where the amalgamation in stage one is LSE, as described, while stage 2 uses a max operation along the row instead of LSE. The first stage post-processing step normalizes the output of the stage, and the second stage post-processing performs the argmax operation described to find the most likely ATCG value at each timestep. The choice of the number of future timesteps to consider during each stage of the lookahead data processing, directly impacts the area and latency of the decoder. More future timesteps being considered results in a larger hardware area being required for the decoder and longer latency, but previously was thought to provide greater accuracy. However, in studying the accuracy implications of varying the number of future steps, the accuracy of the inferred sequence varying by the number of future steps can be obtained. FIG. 16 depicts one example of this in connection with genome sequence accuracy. In the example of FIG. 16, accuracy is noted for different numbers of future steps, where the lookahead function is LSE (LA_{LSE}) as well as max (LAₘₐₓ). As illustrated, it has been discovered in connection with this invention that considering only about 10 future steps for the lookahead processing in both stages results in an accuracy nearly identical to considering all 800 steps (in one embodiment), while reducing latency by 1/80, and consuming much less area and memory.

To summarize, in one embodiment, a decoder and decode process are disclosed herein, for producing outputs of (for instance) a Conditional Random Field algorithm, in which, for each step being produced t of T total steps, only steps before t are considered when producing out_t, and up to n remaining values after t, where n can be between 0 and T−1, as opposed to all remaining steps. This is useful for streaming operations in which steps are received one at a time, and it is desirable to begin producing out values before t=T. One possible embodiment of this disclosure is described below. Aspects of this disclosure include parameterization across multiple parameters, most important being the value of n. Another embodiment of the disclosure is a hardware architecture for implementing the decode process in a streaming fashion when combined with pre-processing to produce the steps being processed. The process is particularly useful in domains involving time-variant inputs, such as genome sequencing and natural language processing (NLP) including written and spoken text analysis.

The following steps are one possible lookbehind data process implementation of a CRF decoder that considers only n timesteps after t:
1. For timestep t, calculate alpha_t by adding x_t (the known input at time t without accounting for next and previous steps) to forward_t−1. Forward_t−1 is a matrix of 0s at t=0, otherwise it is calculated from the previous step t−1 as described in step 2.
2. Calculate forward_t by applying a reducing operator (e.g. log-sum-exponent, max) to alpha_t.
3. Repeat this recursively until t=T, calculating alpha_t for each step t. alpha is “one half” of the final value, representing the output at step t while accounting for all steps.
   Based on step t=n being received from the streaming input, the lookahead data processing with the backwards pass can begin:
1. For timestep n, calculate beta_n−1 by adding n to backward_n. Backward_n is a matrix of 0s at n, otherwise it is calculated from the beta_n as described in step 2 below.
2. Calculate backward_n−1 by applying a reducing operator (e.g. log-sum-exponent, max) to beta_n−1.
3. Repeat recursively until n=t.
4. With alpha_t and backward_t, out_t can be determined by combining (e.g., adding) these two matrices. out_t then represents the output at step t, considering all steps before t and n steps after t.
   Only backward_t is useful for the next steps of the process; backward_t+1 can be redetermined using the above steps once n+1 becomes available. This redetermination requirement motivates a pipelined hardware implementation to efficiently implement the process, for example, in a streaming data device.

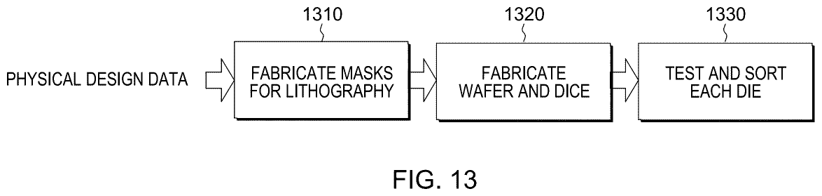

In one or more embodiments, a further step includes fabricating a physical integrated circuit in accordance with an optimized circuit device design. One non-limiting specific example that accomplishes this is described herein in connection with FIGS. 13-15. For example, a decoder design structure is provided to fabrication equipment to facilitate fabrication of a physical integrated circuit in accordance with the design structure.

In one or more embodiments, a layout is prepared based on the analysis. In one or more embodiments, the layout is instantiated as a design structure. In one or more embodiments, a physical integrated circuit is fabricated in accordance with the design structure.

In one or more embodiments, the layout is instantiated as a design structure. A physical integrated circuit is then fabricated in accordance with the design structure, such as depicted in FIGS. 13-15. FIG. 13 is a flow diagram of a design process used in semiconductor design, manufacture, and/or test. Once the physical design data is obtained, an integrated circuit designed in accordance therewith can be fabricated according to known processes that are generally described with reference to FIG. 13. Generally, a wafer with multiple copies of the final design is fabricated and cut (i.e., diced) such that each die is one copy of the integrated circuit. At block 1310, the processes include fabricating masks for lithography based on the finalized physical layout. At block 1320, fabricating the wafer includes using the masks to perform photolithography and etching. Once the wafer is diced, testing and sorting each die is performed at 1330 to filter out any faulty die. Furthermore, referring to FIGS. 13-15, in one or more embodiments, the at least one processor is operative to generate a design structure for the integrated circuit design in accordance with the VLSI design, and in at least some embodiments, the at least one processor is further operative to control integrated circuit manufacturing equipment to fabricate a physical integrated circuit in accordance with the design structure. Thus, the layout can be instantiated as a design structure, and the design structure can be provided to fabrication equipment to facilitate fabrication of a physical integrated circuit in accordance with the design structure. The physical integrated circuit will be improved (for example, because of reduced decoder area and/or memory) compared to circuits designed using prior art techniques. To achieve similar improvements with prior-art techniques, even if possible, would require expenditure of more CPU time as compared to embodiments of the invention.

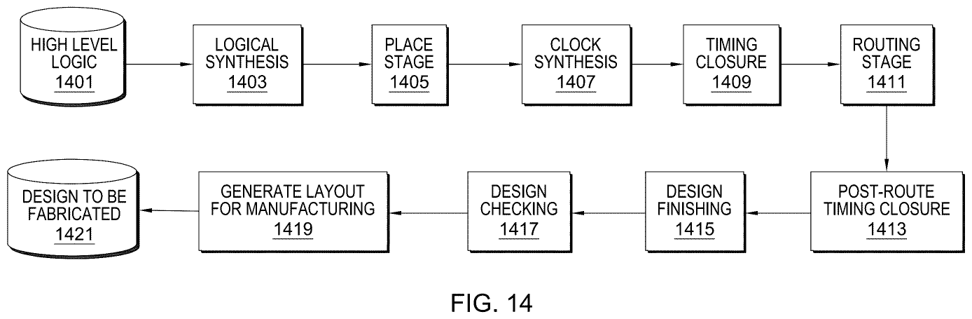

FIG. 14 depicts an example high-level Electronic Design Automation (EDA) tool flow, which is responsible for creating an optimized microprocessor (or other IC) design to be manufactured. A designer can start with a high-level logic description 1401 of the circuit (e.g. VHDL or Verilog). The logic synthesis tool 1403 compiles the logic and optimizes it without any sense of its physical representation, and with estimated timing information. Placement tool 1405 takes the logical description and places each component, looking to minimize congestion in each area of the design. The clock synthesis tool 1407 optimizes the clock tree network by cloning/balancing/buffering the latches or registers. The timing closure step 1409 performs a number of optimizations on the design, including buffering, wire tuning, and circuit repowering; its goal is to produce a design which is routable, without timing violations, and without excess power consumption. Routing stage 1411 takes the placed/optimized design and determines how to create wires to connect the components, without causing manufacturing violations. Post-route timing closure 1413 performs another set of optimizations to resolve any violations that are remaining after the routing. Design finishing 1415 then adds extra metal shapes to the netlist, to conform with manufacturing requirements. Checking steps 1417 analyze whether the design is violating any requirements such as manufacturing, timing, power, electromigration or noise. When the design is clean, the final step 1419 is to generate a layout for the design, representing all the shapes to be fabricated in the design to be fabricated 1421.

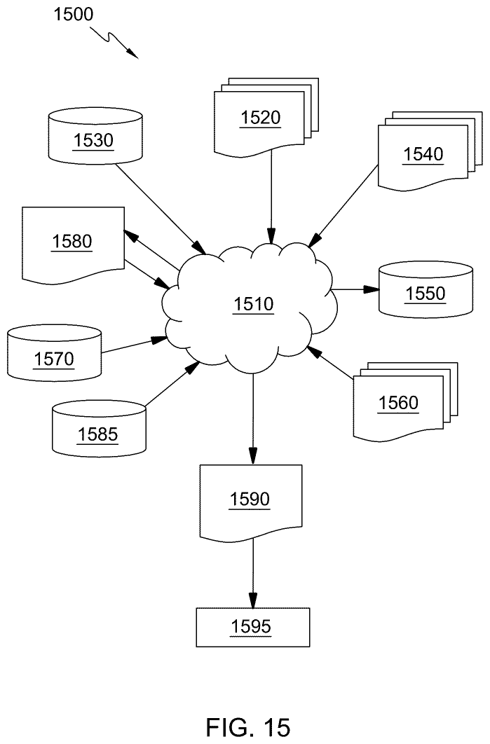

One or more embodiments integrate the decode techniques herein with semiconductor integrated circuit design simulation, test, layout, and/or manufacture. In this regard, FIG. 15 shows a block diagram of an exemplary design flow 1500 used for example, in semiconductor IC logic design, simulation, test, layout, and manufacture. Design flow 1500 includes processes, machines and/or mechanisms for processing design structures or devices to generate logically or otherwise functionally equivalent representations of design structures and/or devices, such as those that can be analyzed using timing analysis or the like. The design structures processed and/or generated by design flow 1500 may be encoded on machine-readable storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g., E-V writers), computers, or equipment for simulating design structures, any apparatus used in the manufacturing or test process, or any machines for programming functionality equivalent representations of the design structures into any medium (e.g., a machine for programming a programmable gate array).

Design flow 1500 can vary depending on the type of representation being designed. For example, a design flow 1500 for building an application specific IC (ASIC) may differ from a design flow 1500 for designing a standard component or from a design flow 1500 for instantiating the design into a programmable array, for example a programmable gate array (PGA) or a field programmable gate array (FPGA).

FIG. 15 illustrates multiple such design structures 1520 that is preferably processed by a design process 1510. Design structure 1520 may be a logical simulation design structure generated and processed by design process 1510 to product a logically equivalent functional representation of a hardware device. Design structure 1520 may also or alternatively comprise data and/or program instructions that when processed by design process 1510, generate a functional representation of the physical structure of a hardware device. Whether representing functional and/or structural design features, design structure 1520 may be generated using electronic computer-aided design (ECAD), such as implemented by a core developer/designer. When encoded on a gate array or storage medium, design structure 1520 may be accessed and processed by one or more hardware and/or software modules within design process 1510 to simulate or otherwise functionally represent an electronic component, circuit, electronic or logic module, apparatus, device, or system. As such, design structure 1520 may comprise files or other data structures including human and/or machine-readable source code, compiled structures, and computer executable code structure that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages, such as Verilog and VHDL, and/or higher level design languages, such as C or C++.

Design process 1510 preferably employs and incorporates hardware and/or software modules for synthesizing, translating, or otherwise processing a design/simulation functional equivalent of components, circuits, devices, or logic structures to generate a Netlist 1580, which may contain design structures such as design structure 1520. Netlist 1580 may comprise, for example, compiled or otherwise processed data structures representing a list of wires, discrete components, logic gates, control circuits, I/O devices, modules, etc., that describes the connections to other elements and circuits in an integrated circuit design. Netlist 980 may be recorded on a machine-readable data storage medium or programmed into a programmable gate array, a compact flash, or other flash memory. Additionally, or in the alternative, the medium may be a system or cache memory, buffer space, or other suitable memory.

Design process 1510 may include hardware and software modules for processing a variety of input data structure system, including Netlist 1580. Such data structure types may reside, for example, within library elements 1530 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 1540, characterization data 1550, verification data 1560, design rules 1570, and test data files 1585, which may include input test patterns, output test results, and other testing information. Design process 1510 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 1510 without deviating from the scope and spirit of the invention. Design process 1510 may also include modules for performing standard circuit design processes such as timing analysis, verification, design rule checking, place and route operations, etc. Improved placement can be performed as described herein.

Design process 1510 employs and incorporates logic and physical design tools such as HDL compilers and simulation model build tools to process design structure 1520 together with some or all of the depicted supporting data structures along with any additional mechanical design or data (if applicable), to generate a second design structure 1590. Design structure 1590 resides on a storage medium or programmable gate array in a data format used for the exchange of data of mechanical devices and structures (e.g. information stored in an IGES, DXF, Parasolid XT, JT, DRG, or any other suitable format for storing or rendering such mechanical design structures). Similar to design structure 1520, design structure 1590 preferably comprises one or 10 more files, data structures, or other computer-encoded data or instructions that reside on data storage media and that when processed by an ECAD system generate a logically or otherwise functionally equivalent form of one or more IC designs or the like. In one embodiment, design structure 1590 may comprise a compiled, executable HDL simulation model that functionally simulates the devices to be analyzed.

Design structure 1590 may also employ a data format used for the exchange of layout data of integrated circuits. and/or symbolic data format (e.g. information stored in a GDSII (GDS2), GLl, OASIS, map files, or any other suitable format for storing such design data structures). Design structure 1590 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described herein (e.g., .lib files). Design structure 1590 may then proceed to a stage 1595 where, for example, design structure 1590: proceeds to tape-out, is released to manufacturing, is released to a mask house, is sent to another design house, is sent back to the customer, etc.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet a further aspect, a process for integrating computing infrastructure comprising integrating computer-readable code into a computer system may be provided. The computer system comprises a computer-readable medium, in which the computer medium comprises one or more embodiments. The code in combination with the computer system is capable of performing one or more embodiments.

Although various embodiments are described above, these are only examples. For example, other models and/or data may be used. Moreover, additional, less and/or other code may be used. Although particular code may be provided as an example of performing a particular operation or task, additional and/or other code may be used. Code may be combined and/or separated into code subsets. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A method of enhancing data processing, the method comprising:
decoding, by a decoder, a series-variant data sequence, the decoding comprising:
storing, by the decoder in intermediate storage, received timestep values of the series-variant data sequence; and
lookahead data processing, by the decoder, a specified number of future timestep values of the series-variant data sequence from a particular timestep, wherein the lookahead data processing for the particular timestep proceeds based on the specified number of future timestep values from the particular timestep being stored by the decoder in the intermediate storage.

2. The method of claim 1, wherein the specified number of future timestep values of the series-variant data sequence being processed by the lookahead data processing of the decoder is less than all future timestep values of the series-variant data sequence from the particular timestep.

3. The method of claim 1, wherein the decoding, by the decoder, further comprises lookbehind data processing prior timestep values from the particular timestep to produce a lookbehind data processing result for the particular timestep, and storing, by the decoder in the intermediate storage, the lookbehind data processing result.

4. The method of claim 3, wherein the decoding further comprises outputting, by the decoder, a stream of discrete output values based, in part, on the lookbehind data processing result and a lookahead data processing result produced by the lookahead data processing, wherein a time-to-first output from the decoder for the series-variant data sequence is dependent on a size of the specified number of future timestep values to be processed by the lookahead data processing of the decoder.

5. The method of claim 1, wherein a size of the intermediate storage is dependent on a size of the specified number of future timestep values to be processed by the lookahead data processing of the decoder.

6. The method of claim 1, wherein timestep values of the series-variant data sequence are obtained by the decoder sequentially, and wherein the storing comprises storing the timestep values sequentially in the intermediate storage for access by the lookahead data processing.

7. The method of claim 6, wherein the lookahead data processing comprises lookahead data processing the specified number of future timestep values from the particular timestep in descending timestep order.

8. The method of claim 1, wherein the specified number of future timestep values being processed by the lookahead data processing is a number specified for a particular decode process implemented in the decoding of the series-variant data sequence.

9. The method of claim 8, wherein the particular decode process comprises a Conditional Random Fields (CRF) process.

10. A computer program product comprising:
a set of one or more computing readable storage media; and
program instructions, collectively stored in the set of one or more storage media, for causing at least one processor to perform operations comprising:
decoding, by a decoder, a series-variant data sequence, the decoding comprising:
storing, by the decoder in intermediate storage, timestep values of the series-variant data sequence; and
lookahead data processing, by the decoder, a specified number of future timestep values of the series-variant data sequence from a particular timestep, wherein the lookahead data processing for the particular timestep proceeds based on the specified number of future timestep values from the particular timestep being stored by the decoder in the intermediate storage.

11. The computer program product of claim 10, wherein the specified number of future timestep values of the series-variant data sequence being processed by the lookahead data processing of the decoder is less than all future timestep values of the series-variant data sequence from the particular timestep.

12. The computer program product of claim 10, wherein the decoding, by the decoder, further comprises lookbehind data processing prior timestep values from the particular timestep to produce a lookbehind data processing result, and storing, by the decoder in the intermediate storage, the lookbehind data processing result.

13. The computer program product of claim 11, wherein the decoding further comprises outputting, by the decoder, a stream of discrete output values based, in part, on the lookbehind data processing result and a lookahead data processing result produced by the lookahead data processing, wherein a time-to-first output from the decoder based on the series-variant data sequence is dependent on a size of the specified number of future timestep values to be processed by the lookahead data processing of the decoder.

14. The computer program product of claim 10, wherein the size of the intermediate storage is dependent on a size of the specified number of future timestep values to be processed by the lookahead data processing of the decoder.

15. The computer program product of claim 10, wherein timestep values of the series-variant data sequence are obtained by the decoder sequentially, and wherein the storing comprises storing the timestep values sequentially in the intermediate storage for access by the lookahead data processing.

16. The computer program product of claim 14, wherein the lookahead data processing comprises lookahead data processing the specified number of future timestep values from the particular timestep in descending timestep order.

17. A system comprising:
at least one processor set;
a set of one or more computing-readable storage media; and
program instructions, collectively stored in the set of one or more storage media, for causing the at least one processor set to perform operations comprising:
decoding, by a decoder, a series-variant data sequence, the decoding comprising:
storing, by the decoder in intermediate storage, received timestep values of the series-variant data sequence; and
lookahead data processing, by the decoder, a specified number of future timestep values of the series-variant data sequence from a particular timestep, wherein the lookahead data processing for the particular timestep proceeds based on the specified number of future timestep values from the particular timestep being stored by the decoder in the intermediate storage.

18. The system of claim 17, wherein the specified number of future timestep values of the series-variant data sequence being processed by the lookahead data processing of the decoder is less than all future timestep values of the series-variant data sequence from the particular timestep. the decoding, by the decoder, further comprises:
lookbehind data processing prior timestep values from the particular timestep to produce a lookbehind data processing result for the particular timestep, and storing, by the decoder in the intermediate storage, the lookbehind data processing result; and
outputting, by the decoder, a stream of discrete output values based, in part, on the lookbehind data processing result and a lookahead data processing result produced by the data lookahead data processing, wherein a time-to-first output from the decoder for the series-variant data sequence is dependent on a size of the specified number of the subset of future timestep values to be processed by the lookahead data processing of the decoder.

19. The system of claim 17, wherein a size of the intermediate storage is dependent on a size of the specified number of future timestep values to be processed by the lookahead data processing of the decoder.

20. The system of claim 17, wherein:
timestep values of the series-variant datastream sequence are obtained by the decoder sequentially;
the storing comprises storing the timestep values sequentially in the intermediate storage for access by the lookahead data processing; and
the lookahead data processing comprises lookahead data processing the specified number of future timestep values from the particular timestep in descending timestep order.
